(19) United States
(12) Patent Application Publication
(10) Pub. No.: US 2022/0242361 A1
(43) Pub. Date: Aug. 4, 2022

(54) Standee Transit Pod

(71) Applicant: Ofer Agam, Daly City, CA (US)

(72) Inventor: Ofer Agam, Daly City, CA (US)

(21) Appl. No.: 17/167,134

(22) Filed: Feb. 4, 2021

(51) Int. Cl. B60R 22/20; B64D 11/06; B60N 3/06

(52) U.S. Cl. CPC B60R 22/20; B64D 11/0611; B60R 2022/208; B64D 11/0643; B60N 3/063; B64D 11/062

(57) ABSTRACT

A standee transit pod having a padded backrest supported by a vertically reclined roll bar and a rear brace bar. The backrest is reclined from vertical by about 8 degrees over a range of 5 to 15 degrees. Additionally there is a safety restraint apparatus for a standee, a platform, a lower rear portion of the brace, which is attached proximate to a mid rear edge of the platform therein providing a right rear open space and a left rear open space on the platform. Where, in a row of transit pods, every other transit pod is staggered rearward about half a length of the platform, therein creating adjoining right rear open spaces and left rear open spaces with the adjacent transit pods, therein providing an aisle for a passenger to walk past the row of the plurality of transit pods.

### FIELD OF THE INVENTION

The present invention relates generally to transit pods that facilitates a standing passenger during transit. More particularly, the present invention is a standee transit pod having a safety restraint apparatus for the standing passenger, wherein the safety restraint apparatus can be adjusted to the passenger's physical dimensions. The invention potentially enables more standing passengers to be safely and comfortably transported on various types of transit vehicles.

### BACKGROUND OF THE INVENTION

Seat belt requirements for transit vehicle are inconsistent. For example, the U.S. DEPARTMENT OF TRANSPORTATION in TP-210-09, in the 1^{st} paragraph of page 4 states, that FMVSS 210 establishes requirements for seat belt assembly anchorages to insure their proper location for effective occupant restraint and to reduce the likelihood of their failure. The standard applies to passenger cars, multipurpose passenger vehicles (MPVs), trucks and buses. FMVSS 210 establishes requirements for seat belt assembly anchorages to insure their proper location for effective occupant restraint and to reduce the likelihood of their failure. The 2nd paragraph then states that the seat belt anchorages for a Type 1 (lap belt) or a Type 2 seat belt assembly shall be installed for each DSP, “except a passenger seat in a bus”. DSP is an acronym for Designated Seating Positions. The exception for buses in the 2^{nd} paragraph contradicts the 1^{st} paragraph, so FMVSS 210 does not in fact establish requirements for buses, and because a bus is a MPV the “except a passenger seat can be interpreted to include MPVs.

Except for side-facing seats, the anchorage, attachment hardware, and attachment bolts for a Type 1 seat belt assembly or the pelvic portion of a Type 2 seat belt assembly, if voluntarily installed, or the pelvic portion of a Type 2 seat belt assembly or automatic seat belt assembly, if equipped with a detachable upper torso belt, shall withstand a 5,000 pound force. The anchorage, attachment hardware, and attachment bolts for a Type 2 or automatic seat belt assembly, installed to comply with FMVSS 208, shall withstand 3,000-pound forces. The attachment hardware of a seat belt assembly subjected to S5.1 or FMVSS 208 other than due to FMVSS 208, S4.1.2.1(c)(2) does not have to meet these requirements. Permanent deformation or rupture of a seat belt anchorage or its surrounding area is not considered to be a failure. FMVSS 208, S4.1.2.1(c)(2) (c) Meet the frontal crash protection requirements of S5.1, in a perpendicular impact, with respect to anthropomorphic test devices in each front outboard designated seating position restrained only by Type 1 seat belt assemblies. The inventor notes that that the key phrase here is “if voluntarily installed” as making an installation optional, not a requirement.

49 CFR Part 665, [Docket No. FTA-2015-0019], RIN 2132-AB11 (Final Rule) states that it recognizes exceptions for a “standee”, stating revision to the pay-loading procedure to recognize the manufacturer's “standee” passenger rating. The final rule does not add any new tests to the existing bus testing program—in fact, per FMVSS 210 doesn't include any standards for a “standee”.

U.S. Pat. No. 5,813,487 to Lee et al. in Col. 1, lines 45-55 teaches that passengers who are seated or stand at the end of the passenger compartment have only limited traveling comfort since, as a result of the rear overhang of the omnibus beyond the rear wheels, bumps in the road surface are passed on to the passengers in an amplified manner.

In summary, the prior art does not teach restraints for standing passengers, aka standees.

### SUMMARY OF THE INVENTION

The invention is a transit pod having safety restraint apparatus for a standee, wherein the safety restraint apparatus can be adjusted to the passenger's physical dimensions. The invention potentially enables more standing passengers to be safely and comfortably transported on various types of transit vehicles. Transit vehicles include ships, certain ferries, most buses and shuttles, passenger cars on trains and subways, MPVs, and certain aircraft.

An aspect of the invention is the transit pod includes a padded backrest having a backside that is supported by a vertically inclined roll bar, wherein an upper portion of the vertical inclined roll bar is braced by at least one vertical brace bar.

A second aspect of the invention is that the transit pod has a platform having a front edge, a rear edge, a left side edge, and a right side edge; wherein the platform functions as a floor for the transit pod.

A third aspect of the invention is that the vertically inclined roll bar has a left lower portion with a left lower end and a right lower portion with a right lower end; wherein the left lower end is attached proximate to the left edge of the structural platform and the right lower end is attached proximate to the right edge of the structural platform; wherein the at least one vertical brace bar has a lower brace portion with a lower brace end that is attached proximate to a rear edge of the platform.

A fourth aspect of the invention is that the transit pod includes a belt assembly restraint system modified to accommodate the standee. Modification of the restraint system can include automated actuation, such that the belts align with a standee's waist and cross the standee's shoulder.

A preferred aspect of the invention is an adjustable knee brace for the standee, which is positioned forward of the standee's position. The adjustable knee brace can be moved forward or rearward to accommodate the size of the standee's lower legs. Pads on the adjustable knee brace can be moved upward or downward to accommodate the height of the standee's knees. When an adult standee relaxes their knees will come into contact with the pads. The standee's flexed legs are cushioned and supported by the knee brace, and the adult standee can stand with essentially very little effort. For standees that are children and/or smaller adults the adjustable knee brace additionally functions as a supplemental element of the belt assembly restraint system.

### BRIEF DESCRIPTION OF THE DRAWINGS

The foregoing invention will become readily apparent by referring to the following detailed description and the appended drawing in which:

FIG. 1 illustrates a side view of the transit pod, wherein an adult standee is indicated as a dashed line;

FIG. 2 illustrates a side view of the transit pod, wherein a smaller standee is indicated by the dashed line;

FIG. 3 illustrates a frontal view the transit pod, albeit without a knee brace, and therefore utilizes a platform that is approximately square;

FIG. 4 illustrates a rear view of the transit pod illustrated in FIG. 3, illustrating the vertically inclined roll bar and the at least one vertical brace bar, which taken together support the backrest and secure the backrest to the structural platform;

FIG. 5a illustrates a planar top view and a planar side view of a first actuator for positioning a turning loop bracket of the automated safety restraint apparatus;

FIG. 5b illustrates a planar top view and a planar side view of a second actuator for positioning a terminal anchor bracket of the automated safety restraint apparatus;

FIG. 5c illustrates a planar top view and a planar side view of a third actuator for positioning a opposing lateral buckle of the automated safety restraint apparatus;

FIG. 6 is a left side planar view of the transit pod with a standee, where the transit pod has an automated safety restraint apparatus that includes a knee brace;

FIG. 7 is a rear side planar view of the transit pod without a standee or a knee brace;

FIG. 8 is a possible layout of the standee transit pod, where a KB pod has a knee brace and a NB pod has no knee brace;

FIG. 9 illustrates Table 1, which contains an algorithm for calculating a standee's shoulder height and waist height based on the standee's total height and gender;

FIG. 10 illustrates Table 2a, which contains height and length of travel of the first actuator; and

FIG. 11 illustrates Table 2b, which contains height and length of travel of the second actuator and the third actuator.

### DETAILED DESCRIPTION OF THE INVENTION

The invention is a standee transit pod 10 having safety restraint apparatus for a standing passenger, wherein the safety restraint apparatus can be adjusted to the passenger's physical dimensions. The invention enables more passengers to be safely and comfortably transported on various types of transit vehicles. Transit vehicles include ships, certain ferries, MPVs, most buses and shuttles, rail passenger cars, subways, and certain aircraft.

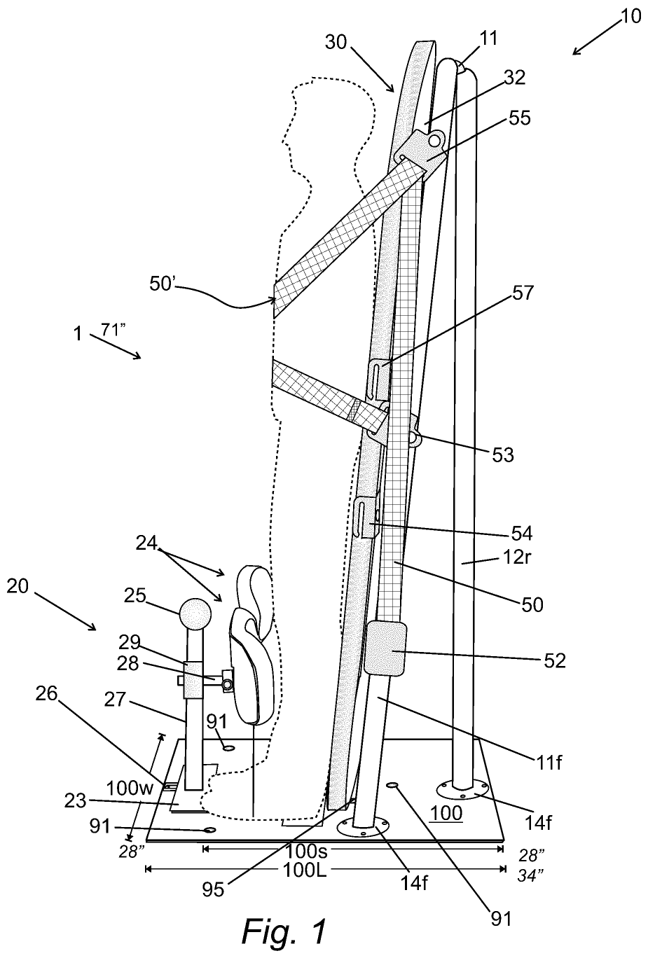

In the embodiment 10 shown in FIG. 1, the standee 1 is 71″ tall, and he is leaning against a padded backrest 30. The backrest is reclined from vertical by about 8 degrees, and within a range of 5 to 15 degrees. An incline of 8 degrees reduces his weight by the cos(82°), which is 0.139, or ˜13.9%. So if he weighs 200 lbs, his legs will only have to support 172.1 lbs, which is 27.9 lbs less.

The inclined backrest 30 has the added advantage that there is enough space for the standee to wear a backpack and/or a sling for a baby.

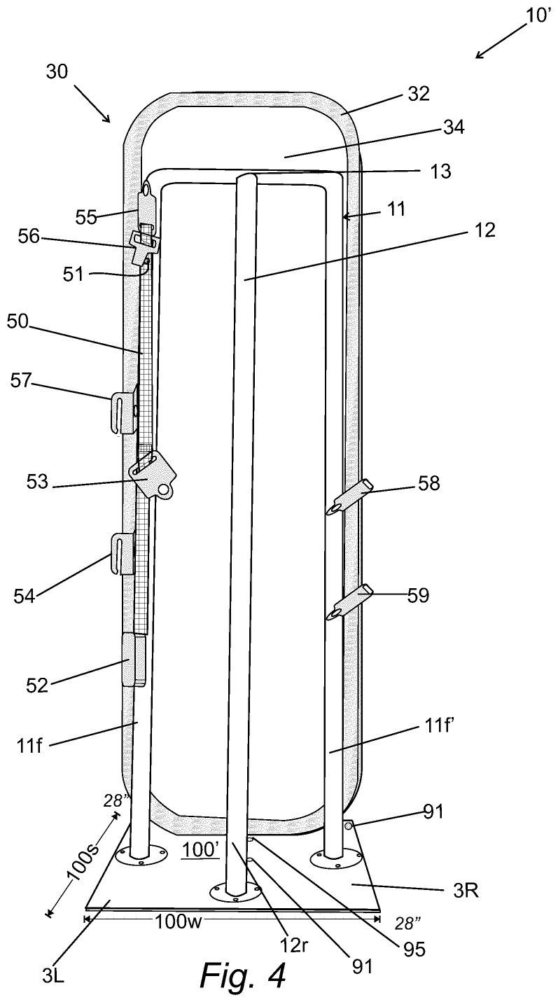

The restraint apparatus shown in FIGS. 1-4 has a waist belt 58 (aka lap belt) that provides additional frictional resistance on the padded backrest 30, as the retractor 52 for the belt keeps the webbed belt somewhat taut. In the embodiment the retractor 52 is mounted on a vertically inclined roll bar 11f. An upper portion of the vertical inclined roll bar 11 (11f and 11f′ shown in FIG. 4) and the at least one vertical brace bar 12 taken together provide a tripod.

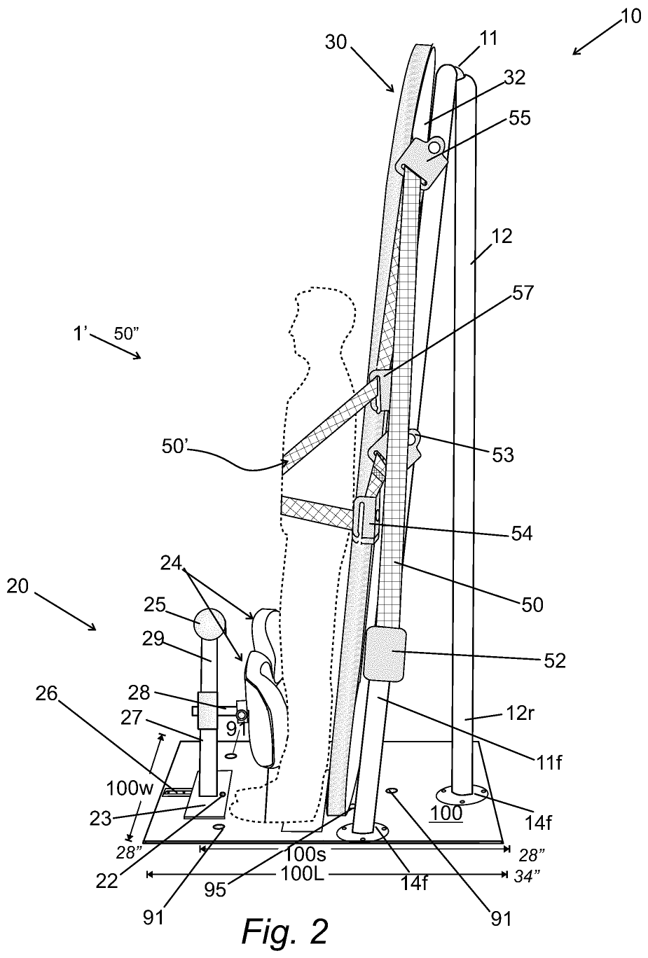

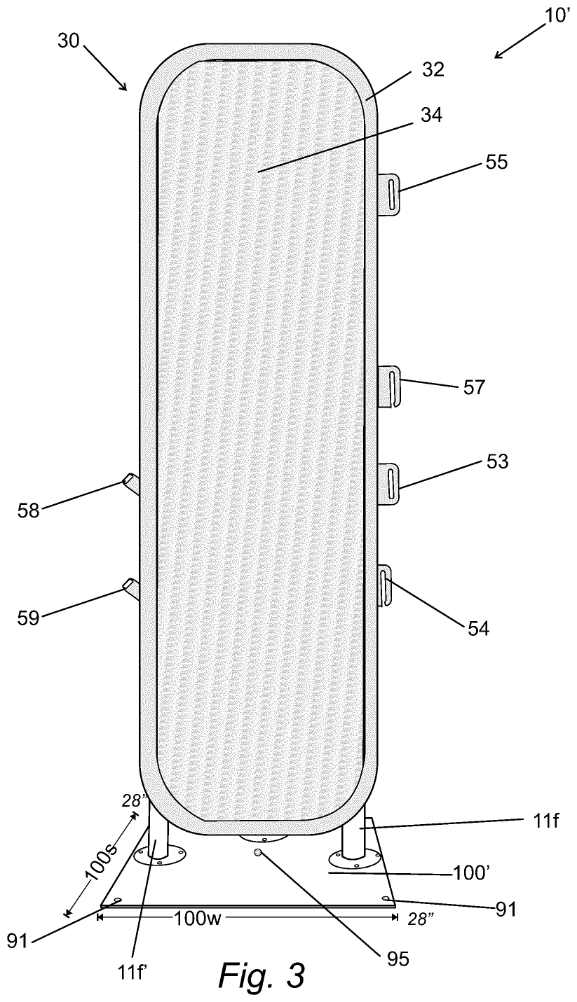

The vertical inclined roll bar 11, as shown in FIG. 2 is braced by the at least one vertical brace bar 12 mounted on platform 100 having a width 100w of about 28″. The lower ends of the roll bars 11f, 11f′(see FIG. 3) and the lower end of brace bar 12r are affixed to the platform using flanges 14f.

The illustrated embodiment of the standee transit pod is sized to accommodate passengers having a height over a range of about 36 inches (914 mm) to about 76 inches (1930 mm). The invention is not limited to this range.

The platform 100 has at least 3 mounting points 91 for affixing the invented pod 10 to a transit vehicle.

Referring again to FIG. 1, a webbed belt 50 when not in use and also when in use, remains at least partially retracted. As with a conventional seat belt assembly, the retractor has a centrifugal lock, so that if the belt is pulled rapidly the lock engages, therein preventing the webbed belt from being pulled out. The webbed belt 50 extends to an upper height through a turning loop bracket 55, and is fastened to a terminal anchor bracket 53. In FIG. 1 the webbed belt 50, using a latch plate 56 (which typically has a sleeved slot) as shown in FIG. 4, an extended portion 50′ of the webbed belt has been pulled across the standee's shoulder and chest, therein simultaneously pulling the webbed belt across the standee's waist, and coupling the latch plate 56 (see FIG. 4) to a opposing lateral buckle 58, as shown in FIG. 3.

In the illustrated embodiment in FIG. 1, the platform dimensions are minimized. The platform 100, with a knee brace 20, is about 34″ long 100L and about 28″ wide 100w. Without the knee brace 20, the platform 100′ is smaller, about 28″ long 100s and about 28″ wide 100w. Inches are shown as italicizes numbers.

A webbed belt shoulder guide 57 and webbed belt waist guide 54 are typically not required when the standee is taller.

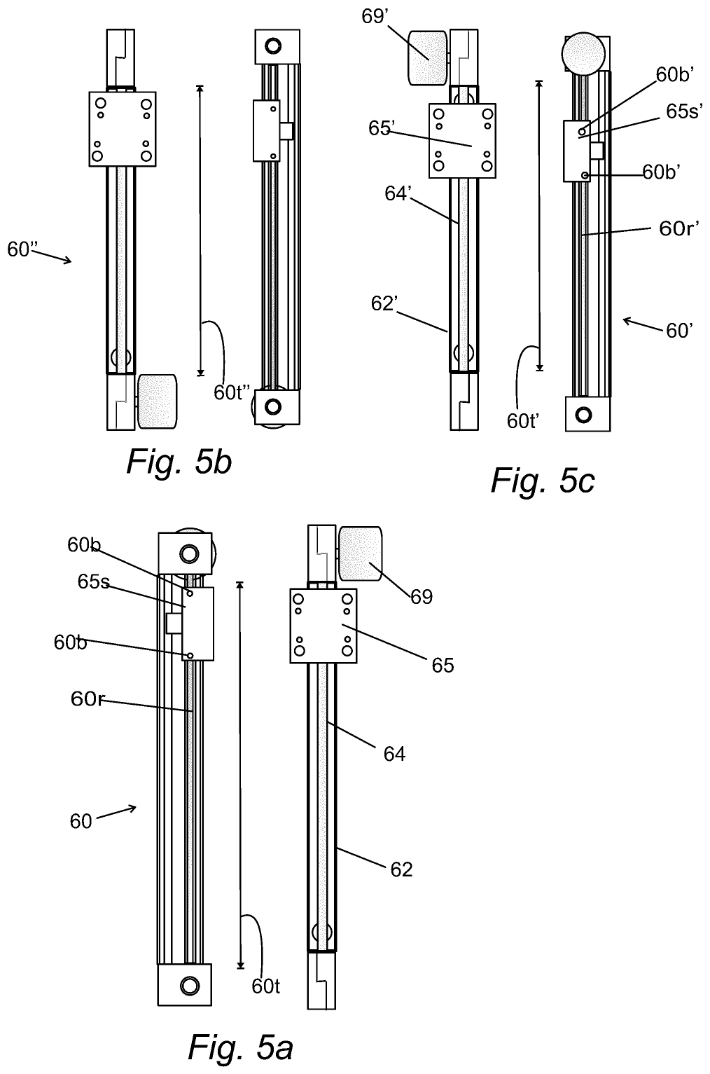

The invention can include a plurality of webbed belt shoulder guides and webbed belt waist guides, unless actuators, as shown in FIGS. 5a, 5b and 5c, are employed.

As shown in FIG. 2, the standee is 50″ tall, the webbed belt 50 is threaded through the webbed belt shoulder guide 57 and webbed belt waist guide 54. The extended portion 50′ of the webbed belt has been pulled across the standee's shoulder and chest, therein simultaneously pulling the webbed belt across the standee's waist, and coupling the latch plate 56 shown in FIG. 4 to an opposing lateral buckle 59, as shown in FIG. 3.

It is anticipated that additional webbed belt shoulder guides and webbed belt waist guides can be added for shorter standees.

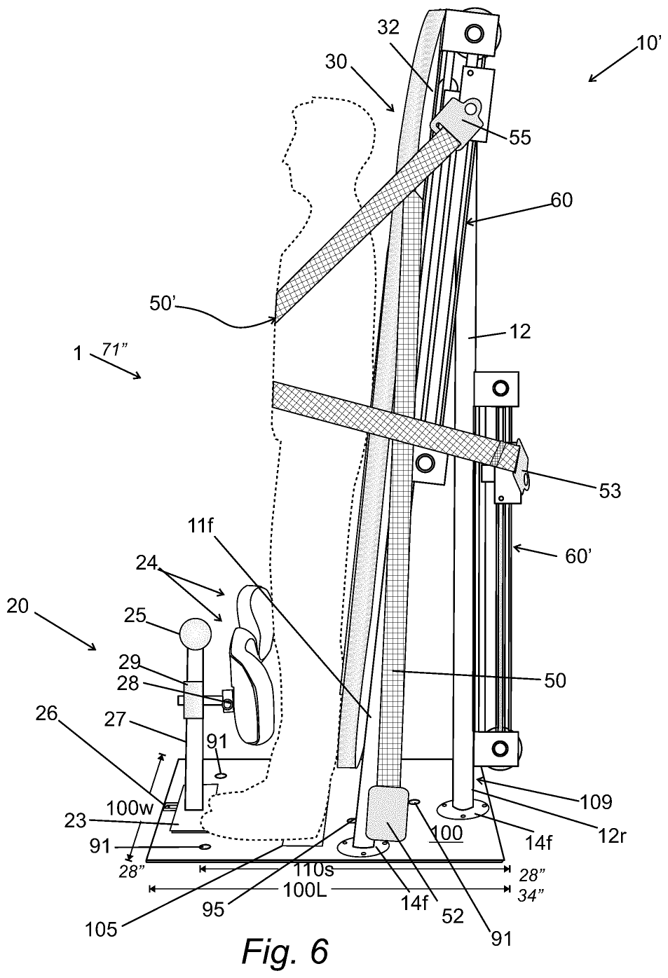

As illustrated in FIG. 1, FIG. 2 and FIG. 6 the knee brace includes a pair of thick oval cupped pads 24. The height of the pair of pads 24 is established by adjusting a T-bracket 29 on a stanchion 27 mounted on a base plate 23. For safety a top end (if present) of the stanchion 27 is preferably terminated with a blunt fitting, such as an elastic ball 25. The base plate 23 can be positioned forward or rearward using an intercoupling track 26 (for example PCB Linear™ cam roller technology—low profile redi rail). Movement along the intercoupling track 26 is prevented by an intercept pin 22, as indicated in FIG. 2. Movement for adjustment is possible when the intercept pin 22 is pulled upwards. The pads 24 are mounted on a horizontal bar 28. The base plate 23 is on about the front ˜6″ of the platform 100.

When a standee flexes his lower legs his knees contact the pads 24. The knee brace 20 is strong enough to support the standee 1 from his knees up. Recall, the inclined backrest reduced the weight of the standee by about 14%, where a 200 lb. standee feels-like he weighs about 170 lbs. Approximately 80% of the standee is above the knee brace 20, so an implemented knee brace 20 further reduces the standee's feels-like weight by about 80%. The remaining weight of a 200 lb. standee is about 34 lbs. The invention can impart a feeling of buoyancy to the standee, as he is supporting only about 17% of his actual weight.

The platform 100 as shown in FIG. 1, FIG. 2, and FIG. 6 has a front edge, a rear edge, a left side edge, and a right side edge. The platform 100 functions as a floor for the transit pod 10. In cases where space for passengers on the transit vehicle is at a premium, then the platform can be made shorter 100s, but with a loss of the knee brace 20. Typically, some combination of transit pods with knee braces and transit pods without knee braces is desired.

FIG. 3 illustrates a frontal view of the transit pod 10′, albeit without a knee brace. The platform 100′ is substantially square. The backrest 30 is padded, with a perimeter pad 32 that is thicker than the main pad 34. In one embodiment, the illustrated backrest has still has the safety restraint apparatus, which includes a plurality of buckles 58 and 59, a terminal anchor bracket 53, at least one waist guide 54 and at least one shoulder guide 57, a turning loop bracket 55, and a latch plate 56 (not visible). The left lower end 11f and the right lower end 11f′ of the roll bar are visible.

FIG. 4 illustrates the rear view of the transit pod 10′ shown in FIG. 3. Most notable in this view is that the brace 12 intersects a midpoint 13 of the roll bar 11, therein leaving open rear corners 3R, 3L on the platform 100′. The open rear corners 3R,3L can be used to provide storage space, or more importantly, walking room for a passenger. If a plurality of transit pods are properly staggered, a plurality of open rear corners 3R,3L forms at least one walking aisle.

Furthermore, as shown in FIG. 4, when the transit pod 10′ is not occupied, the retractor 52 retracts the webbed belt 50, as there always some retraction tension on the webbed belt 50. The webbed belt 50 still loops through the turning loop bracket 55, through the latch plate 56, which is held by a belt button 51, and the webbed belt 50 is anchored in terminal anchor bracket 53. Shoulder guide 57 and waist guide 54 are for adjusting the restraint apparatus for a shorter standee, as shown in FIG. 2. If more guides are needed they are anticipated.

The vertically inclined roll bar 11 of FIG. 4 has a left lower portion 11f with a left lower end and a right lower portion 11f′ with a right lower end; wherein the left lower end is attached proximate to the left edge of the platform and the right lower end is attached proximate to the right edge of the platform; wherein each of the at least one vertical brace bar 12 has a lower brace portion 12r with a lower brace end that is attached proximate to a rear edge of the platform 100′.

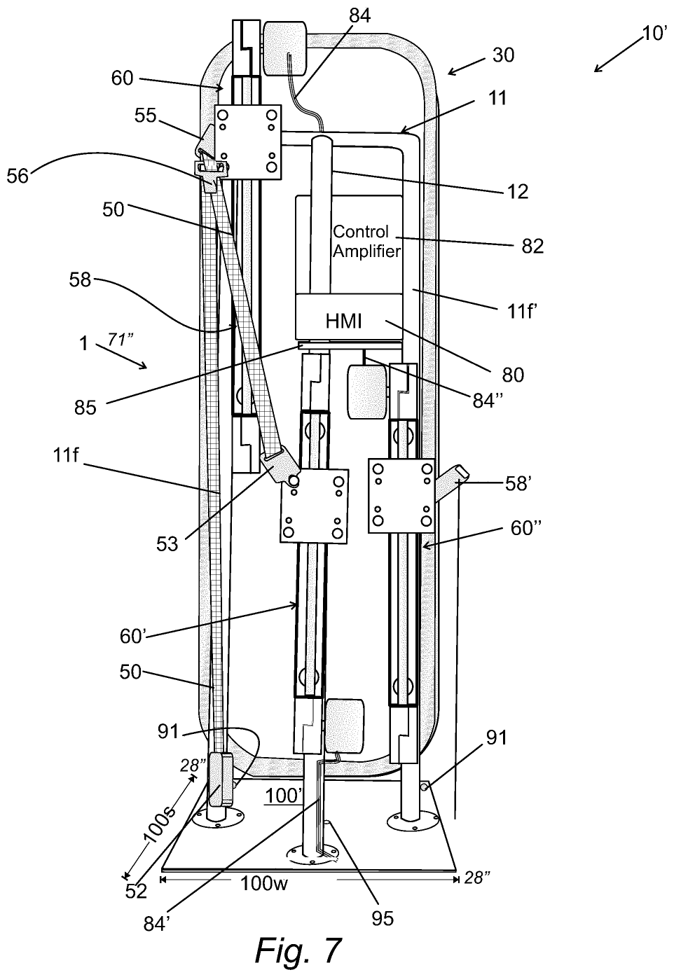

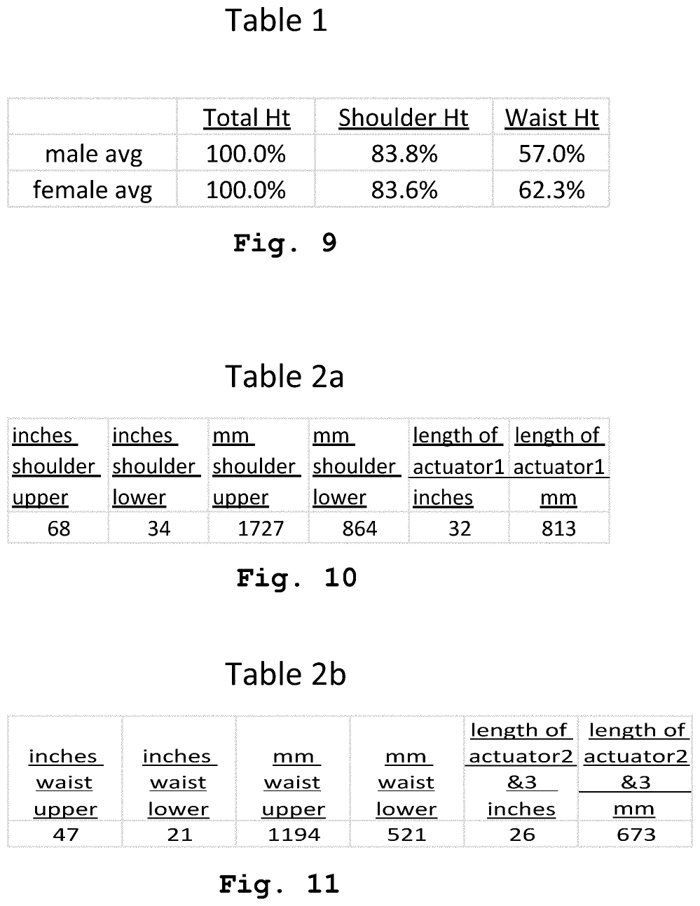

As shown in FIGS. 5a, 5b and 5c the safety restraint apparatus includes actuation by actuators 60, 60′, 60″, which can move to actuated height positions, such that the webbed belt aligns with the standee's waist and across the standee's shoulder. In one embodiment, the first actuator 60 is a Macron Dynamics linear Actuator MSA-628 fitted with a Yaskawa motor 69, wherein the linear actuator has a cart 65 with pairs of bearings 60b on both lateral sides 60s that secure the cart, therein enabling it to roll over a pair of rods 60r. The cart's position is controlled by a motorized belt 64 that nominally is a band of steel mesh impregnated with an elastomeric polymer. The length of travel 60t, as shown in FIG. 5, of the first actuator is about 32 inches (813 mm). The range of length of travel, as shown in Table 2a of FIG. 10, is based on a standee's height, wherein an upper limit height for the standee is a height of about 76 inches. As shown in FIG. 7, the first actuator 60 is mounted at least 30 inches above the platform on an upper portion 11f of the roll bar 11. The cart 65 of the first actuator 60 is fitted with the turning loop bracket 55 (the same element described in FIG. 4 for the safety restraint apparatus), which establishes the height required for the standee's shoulder. The speed of movement of the cart on the first actuator 60 and the second actuator 60′ is slow enough to prevent activation of the retractor's centrifugal lock. Actuation should normally only occur when the webbed belt is not buckled and the transit pod 10′ is not occupied, as shown in FIG. 7.

The second actuator 60′ and a third actuator 60″ are very similar to the first actuator 60, except their length of travel 60t′, 60t″ is about 26 inches (673 mm), as shown in FIG. 5a, FIG. 5b, FIG. 5c and in Table 2b of FIG. 11. As shown in FIG. 6, and FIG. 7 the second actuator 60′ is mounted on the brace 12r and is fitted with a terminal anchor bracket 53.

As shown in FIG. 7, the third actuator 60″ is mounted on an upper portion 12f′ of the roll bar 11 and is fitted with an opposing lateral buckle 58′. A shelf 85 provides support for the controller-amplifier 82 and the Human Machine Interface (HMI) 80. Taken together the foregoing elements form a smart actuated restraint system. Wires 84″ feed to the third actuator motor 60″, wires 84′ feed to the second actuator motor 60′, and wires 84 feed to the first actuator motor 60. The controller-amplifier 82 limits the motor's torque to minimize damage to the actuators if something becomes lodged in the actuator. A force required to retract the webbed belt is less than 10 pounds, so the actuators' force nominally is limited to a similar force.

A port 95 in the platform 100 or platform 100′ without a knee brace provides an inlet for electrical power and an interface to the smart actuated restraint system.

The HMI can calculate the position of the carts on the actuators, based on height and gender. The algorithm is given in Table 1 of FIG. 9. Using the illustrated male who is 71″ tall. the shoulder height is 71×0.838=59.9 inches and the waist height is 71×0.570=40.5 inches. Therefore, the height of the turning loop bracket 55 should be about 60 inches. As illustrated in FIG. 7, the turning loop bracket is at 63 inches, so the first actuator moves the turning loop bracket down 3 inches. The opposing lateral buckle 58′ on the third actuator is currently positioned at 32 inches, so it needs to be moved up 6.5 inches so that it is positioned at 40.5 inches. Likewise the terminal anchor bracket 53 on the second actuator should be moved to a similar height of 40.5 inches.

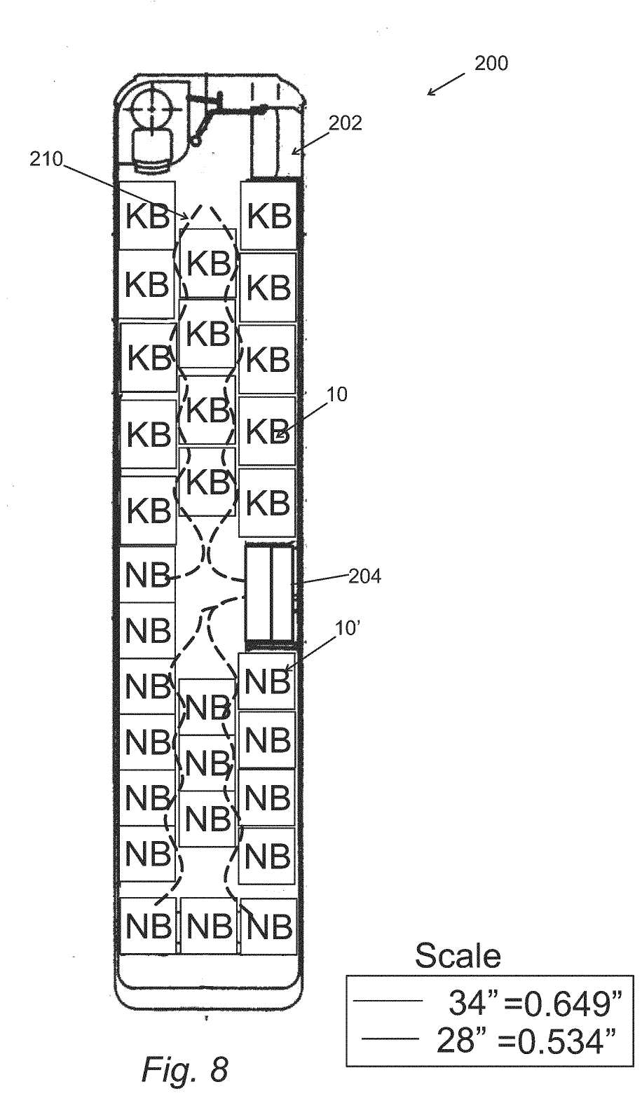

FIG. 8 is a possible layout of the standee transit pod, where a KB pod has a knee brace and a NB pod does not have a knee brace. Dashed lines indicate how a plurality of transit pods can be staggered there creating at least one walking aisle, where a plurality of open rear corners forms the walking aisles.

The illustrated transit vehicle 200 is based on General Motors Bus 5307, which is about 34 ft. long and about 7 ft. wide. It has two sets of stairs 202 (front side) and 204 (rearward side). There are 14 transit pods with knee braces, and 16 transit pods without knee braces 10′. The passenger count is 30, with plenty of waiting space to enter or exit. The General Motors Bus 5307 was estimated to carry 23 passengers. The invented standee transit pod increases the passenger load 30%; while there still remains head room for storage, and with sufficient de-boarding room and boarding room.

It is anticipated that a potential rider could book a ride on a standee transit pod using a webpage, and then track the movement of the transit pod having an updated GPS location. This information could be used to estimate traffic times, and to project an arrival time. Once on the transit vehicle, the passenger could track his movement to his ride destination using his cell phone, and a map app.

Although the present disclosure has been illustrated and described herein with reference to exemplary embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

Finally, any numerical parameters set forth in this Specification and the attached Claims are approximations (for example, by using the term “about”) that may vary depending upon the desired properties sought to be obtained by the present invention. At the very least, and not as an attempt to limit the application of the doctrine of equivalents to the scope of the Claims, each numerical parameter should be construed in light of the number of significant digits and by applying ordinary rounding.

It is to be understood that the foregoing description and specific embodiments are merely illustrative of the best mode of the invention and the principles thereof, and that various modifications and additions may be made to the invention by those skilled in the art, without departing from the spirit and scope of this invention, which is therefore understood to be limited only by the scope of the appended claims.

What is claimed is:

1. A transit pod for a standee, said transit pod comprising:
a padded backrest having a backside that is supported by a reclined from vertical roll bar that is supported by at least one rear brace bar, such that the padded backrest is reclined from vertical by about 8 degrees and within a range of 5 degrees to 15 degrees;
a safety restraint apparatus for the standee, said safety restraint apparatus comprising a belt retractor with a centrifugal lock, an upper lateral turning loop bracket, a latch plate with a slot, a stop button, a terminal anchor bracket, a webbed belt that extends from the belt retractor through the turning loop bracket, through the slot of the latch plate, past the stop and ending in a rearward terminal anchor bracket, and at least one opposing lateral buckle;
wherein pulling the latch plate downward and toward the opposing lateral buckle causes the webbed belt to be pulled across a lateral shoulder and across chest of the standee and, simultaneously, across a waist of the standee, wherein the lateral latch plate can be coupled to at least one opposing lateral buckle;
a platform having a front edge, a rear edge, a left side edge, and a right side edge; wherein the platform functions as a floor for the transit pod; to which is fastened proximate to the side edges of the platform a left lower end and a right lower end of the vertically inclined roll bar; and
a lower rear portion of the brace has a lower rear brace end that is attached proximate to a rear edge of the platform and an upper rear brace portion has a upper rear end that is attached to an upper mid portion of the vertically inclined roll bar.

2. The transit pod according to claim 1, wherein said transit pod further comprises an adjustable knee brace comprising:
a stanchion mounted on a base plate, where the base plate can be positioned forward or rearward using an intercoupling track, wherein movement along the intercoupling track is prevented by an intercept pin;
a pair of thick oval cupped knee pads mounted on a horizontal bar;
an adjustable T-bracket mounted on said stanchion and in connection with the horizontal bar; and
wherein said stanchion provides a component for height adjustment of the knee pads.

3. The transit pod according to claim 1, wherein said transit pod further comprises:
a plurality of lateral webbed belt waist guides at lower height;
a plurality of lateral webbed belt shoulder guides at lower height; and
a plurality of opposing lateral buckles at heights comparable to the webbed belt waist guides.

4. The transit pod according to claim 1, wherein said padded backrest has a height of about 72 inches.

5. The transit pod according to claim 1, wherein the platform is square about 28″ wide and about 28″ long.

6. The transit pod according to claim 2, wherein the platform is rectangular about 28″ wide and about 34″ long.

7. A transit pod for a standee, said transit pod comprising:
a padded backrest having a backside that is supported by a reclined from vertical roll bar that is supported by at least one rear brace bar, such that the padded backrest is reclined from vertical about 8 degrees and within a range of 5 degrees to 15 degrees;
an automatic safety restraint apparatus for the standee, said safety restraint apparatus comprising a belt retractor with a centrifugal lock, an upper lateral turning loop bracket affixed to a first linear actuator cart, a latch plate with a slot, a stop button, a lateral terminal anchor bracket affixed to a second linear actuator cart, a webbed belt that extends from the belt retractor through the turning loop bracket, through the slot of the latch plate, past the stop button, and ending in the lateral terminal anchor bracket affixed to the second linear actuator cart, and an opposing lateral buckle affixed to a third linear actuator, a controller/amplifier, and a human machine interface (HMI);
wherein upon entering a standee's gender and height enables the HMI, using an algorithm, to calculate positions and initiate movement to a shoulder position for the upper lateral turning loop bracket affixed to the first linear actuator cart, a lateral waist position for the lateral terminal anchor bracket affixed to the second linear actuator cart; and to an opposing lateral waist position for the opposing lateral buckle affixed to the third linear actuator cart;
wherein a standee pulling the latch plate downward and toward the opposing lateral buckle causes the webbed belt to be pulled across a lateral shoulder and across a chest of the standee and, simultaneously, across a waist of the standee, wherein the lateral latch plate can be coupled the opposing lateral buckle affixed to the third linear actuator cart;
a platform having a front edge, a rear edge, a left side edge, and a right side edge; wherein the platform functions as a floor for the transit pod; to which is fastened proximate to the side edges of the platform a left lower end and a right lower end of the vertically inclined roll bar; and
a lower rear portion of the brace has a lower rear brace end that is attached proximate to a rear edge of the platform and an upper rear brace portion has a upper rear end that is attached to an upper mid portion of the vertically inclined roll bar.

8. The transit pod according to claim 7, wherein said transit pod further comprises an adjustable knee brace comprising:
a stanchion mounted on a base plate, where the base plate can be positioned forward or rearward using an intercoupling track, wherein movement along the intercoupling track is prevented by an intercept pin;
a pair of thick oval cupped knee pads mounted on a horizontal bar;
an adjustable T-bracket mounted on said stanchion and in connection with the horizontal bar;
wherein said stanchion provides a component for height adjustment of the knee pads.

9. The transit pod according to claim 7, wherein said transit pod further comprises:
a plurality of lateral webbed belt waist guides at lower heights;
a plurality of lateral webbed belt shoulder guides at lower heights; and
a plurality of opposing lateral buckles at heights comparable to the webbed belt waist guides.

10. The transit pod according to claim 7, wherein said padded backrest has a height of about 76 inches.

11. The transit pod according to claim 7, wherein the platform is square about 28″ wide and about 28″ long.

12. The transit pod according to claim 8, wherein the platform is rectangular about 28″ wide and about 34″ long.

13. A plurality of transit pods for a standee, each transit pod comprising:
a padded backrest having a backside that is supported by a reclined from vertical roll bar that is supported by at least one rear brace bar, such that the padded backrest is reclined from vertical about 8 degrees and within a range of 5 degrees to 15 degrees;
a safety restraint apparatus for the standee;
a platform having a front edge, a rear edge, a left side edge, and a right side edge; wherein the platform functions as a floor for the transit pod; to which is fastened proximate to the side edges of the platform a left lower end and a right lower end of the vertically inclined roll bar; and
a lower rear portion of the brace has a lower rear brace end that is attached proximate to a mid rear edge of the platform and an upper rear brace portion has a upper rear end that is attached to an upper mid portion of the vertically inclined roll bar; wherein attachment to the mid rear edge of the platform provides a right rear open space and a left rear open space on the platform;
a row of the plurality of transit pods, wherein every other transit pod is staggered rearward about half a length of the platform, therein creating adjoining right rear open spaces and left rear open spaces with the adjacent transit pods, and the adjoining right rear open spaces and left rear open spaces provides an aisle for a passenger to walk past the row of the plurality of transit pods.

14. The plurality of transit pods according to claim 13, wherein each transit pod further comprises an adjustable knee brace comprising:
a stanchion mounted on a base plate, where the base plate can be positioned forward or rearward using an intercoupling track, wherein movement along the intercoupling track is prevented by an intercept pin;
a pair of thick oval cupped knee pads mounted on a horizontal bar;
an adjustable T-bracket mounted on said stanchion and in connection with the horizontal bar;
wherein said stanchion provides a component for height adjustment of the knee pads.
